(19) United States
(12) Patent Application Publication
(10) Pub. No.: US 2020/0065916 A1
(43) Pub. Date: Feb. 27, 2020

(54) Smartphone Dating Application Based on the Users Contact Lists

(71) Applicant: Meir Dahan, Adi (IL)

(72) Inventor: Meir Dahan, Adi (IL)

(21) Appl. No.: 16/111,709

(22) Filed: Aug. 24, 2018

(51) Int. Cl. G06Q 50/00; H04M 1/2745; G06F 17/30

(52) U.S. Cl. CPC G06Q 50/01; G06F 17/30867; H04M 1/2745

(57) ABSTRACT

A method for smartphone dating application performed by processing devices running on a smartphone. The method enables the user to create a dating profile associated with his mobile phone number. The method enables the user to share the mobile phone numbers of his contact list. The method lists these phone numbers as his first contact circle, and creates a second contact circle based on his contact list and on mobile phone numbers in contact lists that other users shared with the dating application. The method identifies phone numbers associated with dating profiles of other users with phone numbers at the first and second contact circle and enables the user to view and communicate with these dating profiles. The method displays on the smartphone of the user a contact-chain-display between him to other dating profiles while he is viewing them.

### TECHNICAL FIELD

The present invention refers generally to a method for smartphone dating application that may be performed by processing devices running on the smartphone and/or a server that primarily based on the contact lists in the smartphones of the users.

### BACKGROUND ART

Many people believe, rightfully, that romantic dates with friends and the friends of their friends have greater potential to lead to a romantic and serious relationship. However, in many cases, a person is not aware of the fact that two of his acquaintances are looking for new relationship, and even if he actually aware of that, he is not always initiates such matchmaking simply because this issue does not come up when he meets with his acquaintances. The present patent application discloses a method for smartphone dating application that provide good solution for that issue and it is basically designed to enable a user to find a date amongst the members of his contact list and the members of the contact lists of the member of his contact list, i.e., amongst his friends and amongst the friends of his friends.

In addition, many people use dating applications for smartphone as a way to find dates. Tinder, Match, PlentyOfFish, OkCupid, are known dating applications for example. In those and almost all of the dating applications the user is registered and then he may contact other users. The existing dating applications have several known problems. For example, many users create non-genuine profiles, and in addition, some users use a non-polite approach toward other users when communication with them through the dating applications. The disclosed smartphone dating application based on features that are likely to reduce the likelihood of such behavior.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that shows a smartphone (20) and a server (100), each with a processing device (10).

FIG. 2 illustrates a dating profile (50) when presented on a screen of a smartphone (20).

FIG. 3 illustrates a first contact circle (11) when presented on the screen of a smartphone (20).

FIG. 4 illustrates the dating profiles (51) and (52) when presented on the screen of the user's smartphone (20).

FIG. 5 illustrates the contact-chain-display (6) between James and Debora as presented on the smartphone of James.

FIG. 6 illustrates the contact-chain-display (6) between Debora and James as presented on the smartphone of Debora.

FIG. 7 illustrates the photo (7) of Amy with the notification (9) as may appear in the contact lists (8) of her friends.

FIG. 8 is an illustrative block diagram of a first contact circle (11), a second contact circle (12), a third contact circle (13) and a fourth contact circle (14).

FIG. 9 is an illustrative block diagram of the dating profiles (51)-(54).

### THE INVENTION

For the sake of fluency we use in this patent application and in the claims masculine gender (he, his, him and the like), although this also includes the feminine gender. In addition, the terms hereinafter have in this patent application and in the claims the ordinary meanings and also additionally the meaning as stated beside each of them. These terms may be used in the application and the claims in plural or singular.

The term “smartphone” refers to any kind of mobile device which is designed to receive calls by cellular network or internet and that has an internet connection. In addition, we also use the word “smartphone” as the tool for using the method, but, this term also refers to any kind of computer that has an internet connection such as tablets, notes, P.C., and the like, as a tool for operating and using the method. The term “contacts” or “contact list” refers to the mobile phone numbers that are stored in the contact list in the smartphone, and also, by context, to the people themselves who these are their phone numbers.

The term “first contact circle” refers to the contact list of the user, i.e., contacts that stored in the smartphone of the user. The term “second contact circle” refers to contacts of the first contact circle. The term “third contact circle” refers to contacts of the second contact circle. The term “fourth contact circle” refers to contacts of the third contact circle; and, mutatis mutandis, the fifth and sixth circles and so on. The term “processing device” refers to a processing device on a server or on a smartphone, or on both. The processing device may include computing device.

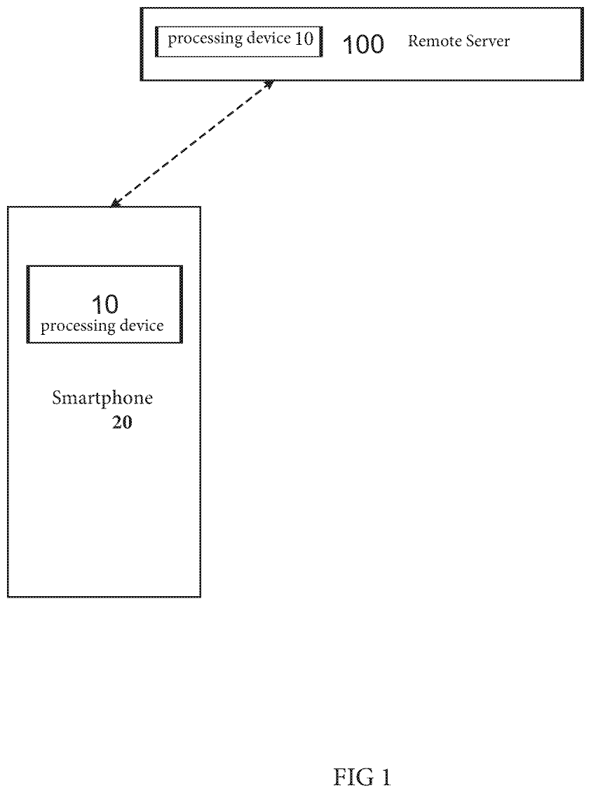

The main object of the present patent application is to provide a method performed by processing device (10) running on a smartphone (20) and/or on a server (100) for a smartphone dating application. FIG. 1 is a block diagram that shows a smartphone (20) and a server (100), both with a processing device (10). The dotted line between the server and the smartphone refer to an internet communication.

A smartphone application is used as a framework for the overall operation and using of the method and for the sake of fluency we will use the terms “smartphone dating application” and “method” hereinafter and in the claims in this connection and as having in general the same meanings.

The smartphone dating application is primarily based for each user on his first contact circle (11) and his second contact circle (12). The user can download the smartphone dating application to his smartphone (20). The smartphone dating application includes all or parts of the following features:

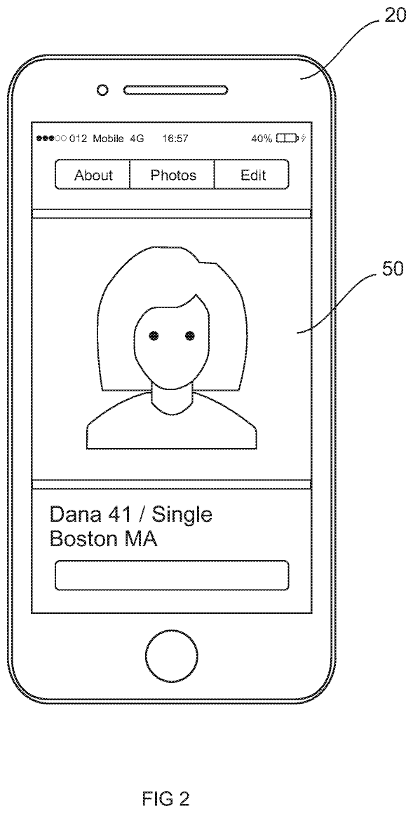

The smartphone dating application enables the user of the smartphone (20) to create a dating profile (50) in the smartphone dating application. The dating profile (50) may be for example as in any typical and standard dating application and may include, the name or a nick-name of the user, the gender, the age, and also may include the possibility to add or to write text about his preferences regarding a date that he is looking for. The smartphone dating application enables the user to download and add his photo or photos to his dating profile (5), possibly in the same ways and manners as in typical and standard dating applications. FIG. 2 illustrates a dating profile (50) when presented on the screen of the smartphone (20).

The smartphone dating application associates the dating profile of the user with the mobile phone number that is operated on said smartphone. The mobile phone number may serves as an identification number of the dating profile of the user.

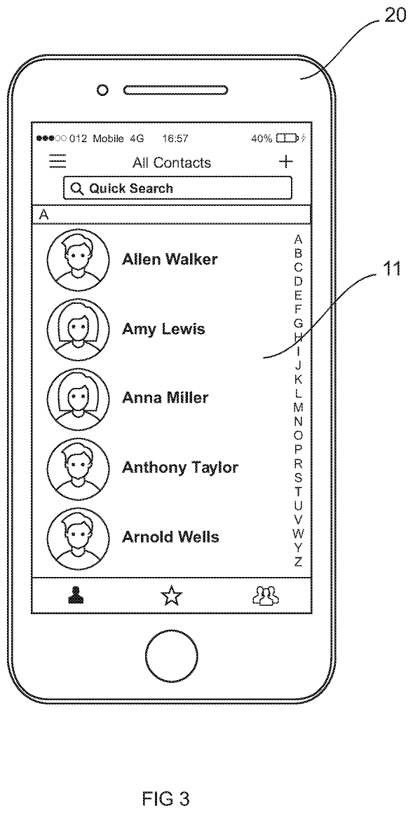

The smartphone dating application enables the user to share with the smartphone dating application the mobile phone numbers of his contact list in said smartphone, i.e., the mobile phone numbers of his contacts in said smartphone, possibly including their international prefix. FIG. 3 illustrates a contact list, i.e., a first contact circle (11) when presented on the screen of a smartphone (20).

The smartphone dating application lists said mobile phone numbers in said contact list of the user as his first contact circle.

The smartphone dating application creates a second contact circle for the user. The second contact circle is based on the contact list of the user and on mobile phone numbers in contact lists that other users shared with the smartphone dating application. The smartphone dating application creates a third and fourth contact circles for said user that are also based on the contact list of the user and on the mobile phone numbers in the contact lists that other users shared as explained above.

The smartphone dating application identifying the phone numbers that are associated with the dating profiles of the other users with the phone numbers that are included in the first contact circle and in the second contact circle. In this way, the smartphone dating application classifies the dating profiles of the other users as being dating profiles (51) of the first contact circle (11) of he user, as being dating profiles (52) of the second contact circle (12), and so forth; This according to the mobile phone numbers that are associated with the dating profiles in the smartphone dating application.

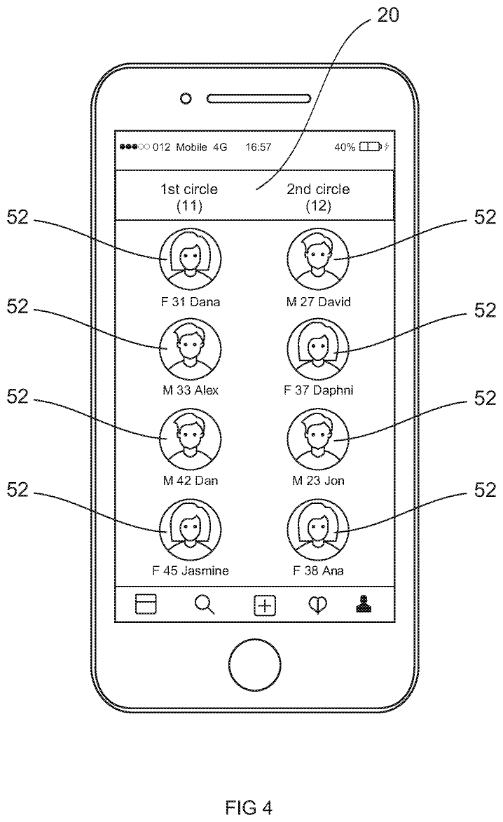

The smartphone dating application enables the user to view dating profiles of users of the smartphone dating application that their phone numbers are included in his first contact circle (11). The dating smartphone application may also enable the user to view dating profiles of users of the smartphone dating application that their phone numbers are in his second contact circle (12), and possibly the same as to the third contact circle and the fourth contact circle. FIG. 4 illustrates for example the dating profiles (51) of the first contact circle (11) and the dating profiles (52) of the second contact circle (12) when displayed on the screen of the user's smartphone (20).

The smartphone dating application displays on the smartphone of the user a contact-chain-display (6) between him to a certain dating profile (55) while the user viewing said certain dating profile. For example, in case when the first contact circle of the user includes Bob, the first contact circle of Bob includes Charles, and the first contact circle of Charles includes Diana, then the contact-chain-display (6) between said user to Diana is: User - - - Bob - - - Charles - - - Diana.

The dating smartphone application enables the user to communicate with other users that their dating profiles are viewable for the user, for example by text messages and the like. In addition, the dating smartphone application enables the user to select what kind of dating profile that he or she wants to view, based on gender, age, and even distance or location as customary in dating applications.

The dating smartphone application may also enable the user to associate his photo (7) in the contact lists (8) of his first contact circle, regardless of whether they are also users of the smartphone dating application, wherein said photo includes a notification (9) that he is a user of said smartphone dating application.

As explained above, the smartphone dating application lists the contact list of the user as his first contact circle. In addition, as explained, the smartphone dating application creates the second contact circle for each user, based on the contact list of the user and on the mobile phone numbers in the contact lists that other users shared with the smartphone dating application. The smartphone dating application identifies phone numbers that appear in the contact lists of the users' contacts, which form the basis for creating the second contact circle for that user. These identified phone numbers should be go through a process of de-duplication (to delete numbers that repeat themselves and to leave one of each) and also to delete phone numbers that already includes in the first contact circle. On the same principles, the smartphone dating application creates the third contact circle and so forth. I.e., the method includes the saving and analyzing of the mobile phone numbers of the contact lists that are shared by the users of the dating smartphone application for creating those circles for each user. From that, it is understood that the contact circles of user A are different that the contact circles of user B.

As explained above, the smartphone dating application enables the user to view dating profiles of users of the smartphone dating application that their phone numbers are included in his first contact circle (11), in his second contact circle, his third contact circle (13), fourth contact circle (14), and so on. The smartphone dating application compares the phone numbers associated with the dating profiles of the users with the phone numbers of those contact circles. In this way, the smartphone dating application classifies the dating profiles of the users as being dating profiles (51) of the first contact circle (11), as being dating profiles (52) of the second contact circle (12), and so forth, according the mobile phone numbers that are associated with the dating profiles in the smartphone dating application. It is means, that the smartphone dating application analyzes those phone numbers and associates each dating profile according to its mobile phone number with each specific user as his first contact circle, second contact circle, third contact circle (13), fourth contact circle (14), and so on, or as not related to this specific user.

The ways and systems for doing such association, comparison and classification between and amongst internet profiles based on the phone numbers of the users of these profiles are known in the general art of smartphone applications. For example, the smartphone application WhtasApp in which each user can see in the application other users that their phone numbers are included in his contact list. The term “mobile phone number” in this patent application and in the claims refers to mobile phone number and also to any identification number or name that serve as identification in any kind of contact list and not exclusively to a mobile phone number, as customary for example in Messenger, Skype, Instagram and the like.

When the number of users in the smartphone dating application is large enough, the user may find a date amongst people from his first contact circle or his friends' contact circles (i.e. the second contact circle and so forth). The smartphone dating application actually may serve like the traditional method of dating, when a person suggests to his acquaintance to meet for a date another acquaintance.

The communications in the smartphone dating application are likely to be more polite and civilized and the likelihood of falls and non-genuine profiles reduced due to the fact that no one would like that his friends in his contact list (his first contact circle) will see a falls profile associated with him. In addition, it is also seems preferable to a person to try to find a date and a romantic connection amongst friends and their friends rather that to dig in millions of strangers' profiles as in other dating apps.

Furthermore, when the number of users in the smartphone dating application is large enough, the dating smartphone application enables each user to know who of his first contact circle is actively looking for a relationship. For example, almost every person has about 200 contacts who are not family members or close friends, but just acquaintances, professionals and colleagues, etc. If the user will know who from his first contact circle is actively looking for a romantic connection it may give him reason and ‘courage’ to initiate a communication about a date or even to offer to those people to date with someone from his personal circle of acquaintances.

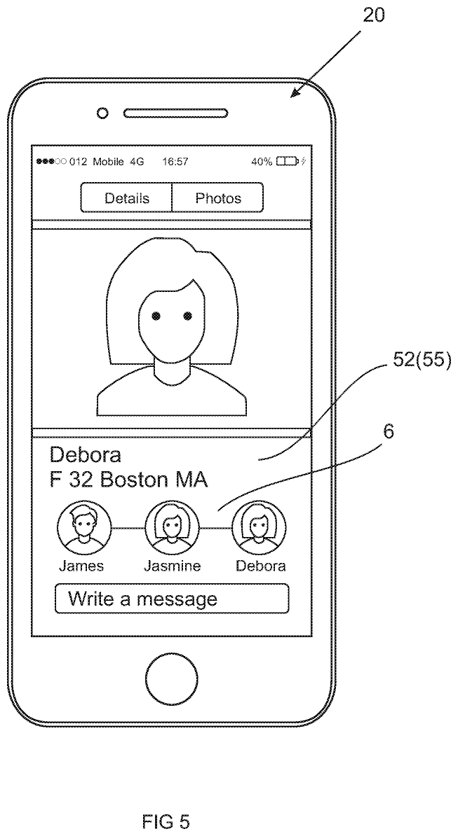

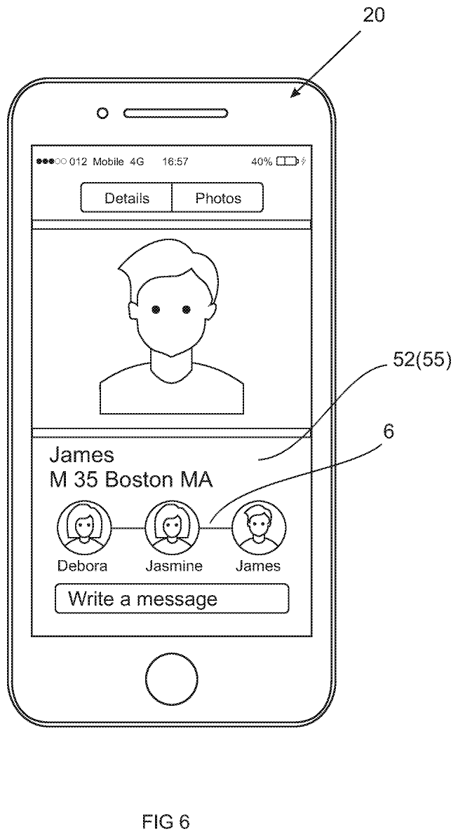

The smartphone dating application displays before the user said dating profiles. When displaying them before the user the dating smartphone application also displays the contact-chain-display (6) between him to each of said dating profiles. FIG. 5 illustrates for example the contact-chain-display (6) between James and Debora as displayed on the smartphone of James and FIG. 6 illustrates the contact-chain-display (6) between Debora and James as displayed on the smartphone of Debora.

Displaying the contact-chain-display (6) on the screen of the smartphones (20) of two users who communicate one with the other through the dating smartphone application is an important structure that creates a psychological aspect of the dating smartphone application. The users, when communicating with each other, can see how they are related to each other simply by seeing the contact-chain-display. For example, User A has a friend B in his contacts and user D has a friend C in his contacts. B and C are in the contacts of each other (or even one of them). User A knows that C is a fiend of D, and that his friend B is a friend of C too, and this relations links make the users to behave properly in few aspects. First, no falls profiles. Second, the users are likely to be more polite to each other. Third, refraining themselves from writing to other users just like that and without serious reason. In many dating sites, users ‘collects’ phone numbers of other users and they do not call, because it is hard to call and communicate with dozens of people in the same period. The fact that when user A view the profile of D he sees in front of his eyes that his friend B is a friend of C that knows D, make this strong psychological impact that lead to those positive approaches, that are so needed in the internet dating world.

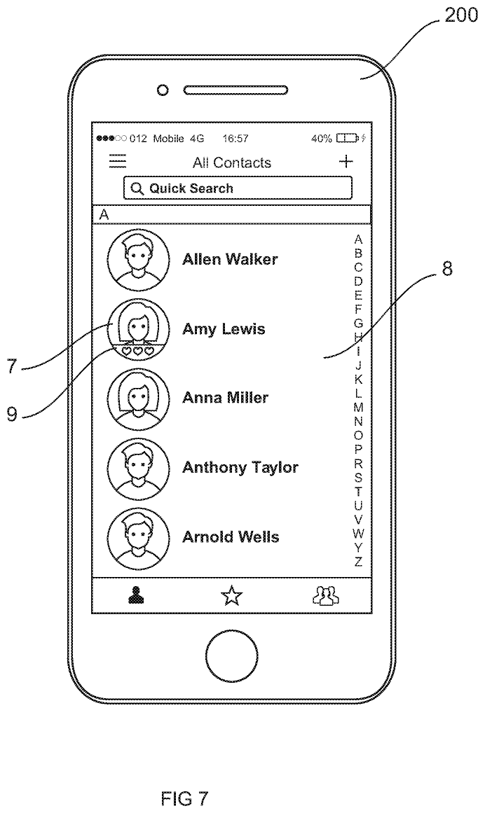

It is knows that a user of a smartphone can download his photo and associate this photo with his contact information as appeared in the contact lists (8) of his friends, i.e., the first contact circle. This photo (7) appears in the contact list in the smartphones (200) of the users beside his name, as illustrated for example, in FIG. 7, in which the contact list (8) of a smartphone (200) includes several people including Amy that beside her name appears her photo. The dating smartphone application may also enable the user to associate his photo (7) in the regular contact lists (8) of his first contact circle, regardless of whether they are also users of the smartphone dating application, wherein said photo includes a notification (9) that he is a user of said smartphone dating application.

FIG. 7 illustrates the situation in which Amy is a user of the dating smartphone application and her photo (7) as appeared in the contact lists (8) of her friends includes now a notification (9) that she is a user of the smartphone dating application. The notification may in words, logo, symbols and the like. The purpose of this feature is to inform her contacts about the smartphone dating application and to motivate them to join too and it is also an explicit declaration that she is looking for a new relationship, and her friends in her contacts are invited to introduce to her a nice person for a date.

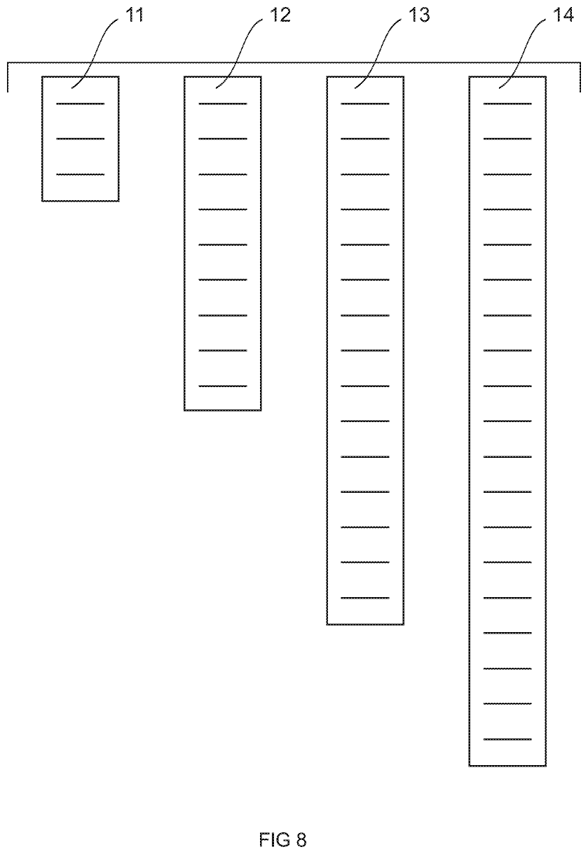

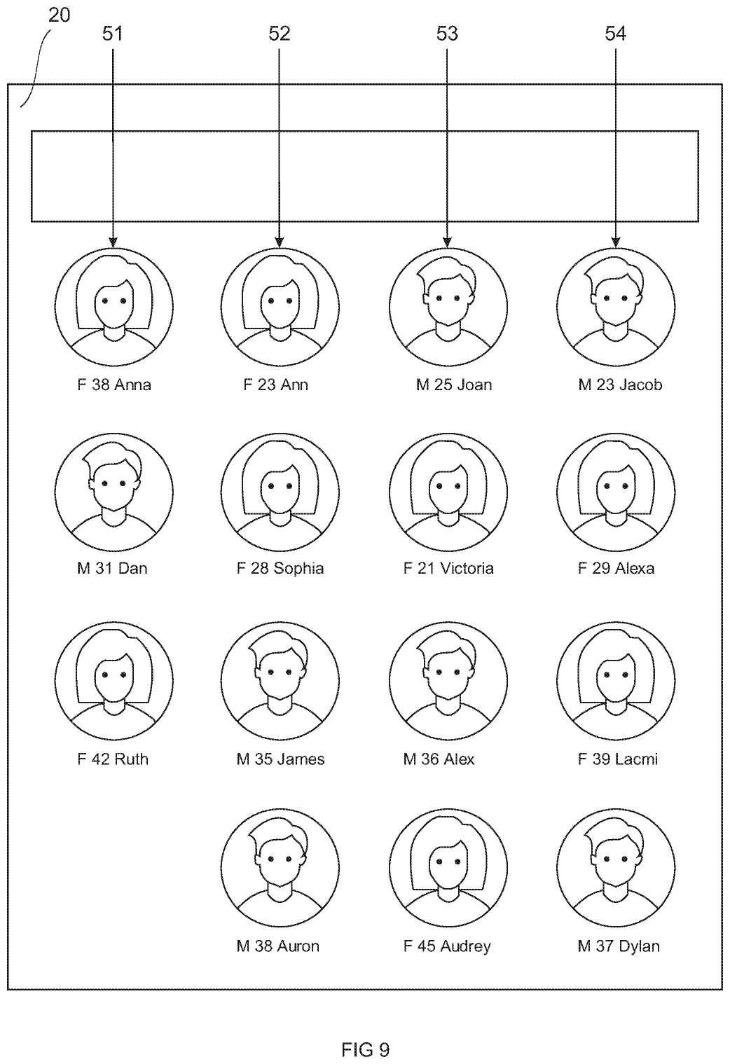

FIG. 8 is an illustrative block diagram of the first contact circle (11), the second contact circle (12), the third contact circle (13) and the fourth contact circle (14). The diagram of FIG. 8 does not include names but just rectangles and short lines that represent those contact circles and the names of the people who are included in those circles. FIG. 9 is an illustrative block diagram of the dating profiles (51) of the first contact circle (11), the dating profiles (52) of the second contact circle (12), the dating profiles (53) of the third contact circle (13) and the dating profiles (54) of the fourth contact circle (14).

In average, any person has 200 people in his contact list (his first contact circle). That means that his second contact circle is likely to include about 5,000 people (arithmetically the number is 40,000 but this number is reduced due to de-duplication), and his third contact circle is likely to include 20,000 (after de-duplication). Statistically about 10 per-cents of the people between 20 to 50 years old are using dating apps. That means that the possible amount of relevant dating profiles for each user is substantial sufficient for dating and likely for finding a relationship.

We can summarize the method for the smartphone dating application that is performed by the processing devices running on the smartphone and the server, as a method that includes the following steps and features:

(A) Enabling the user of the smartphone to create a dating profile;

(B) Associating said dating profile with a mobile phone number of the user that is operated on said smartphone;

(C) Enabling the user to share with said smartphone dating application mobile phone numbers of his contact list in said smartphone;

(D) Listing said mobile phone numbers in said contact list of the user as his first contact circle;

(E) Creating a second contact circle for the user, wherein said second contact circle is based on the contact list of the user and on mobile phone numbers in contact lists that other users of the smartphone dating application shared with the smartphone dating application;

(F) Identifying phone numbers that are associated with dating profiles of said other users with phone numbers that are included in the first contact circle and in the second contact circle of the user;

(G) Classifying said dating profiles of said other users as being dating profiles of the first contact circle or as being dating profiles of the second contact circle;

(H) Enabling the user to view the dating profiles of the other users that their mobile phone numbers are included in the first contact circle of the user;

(I) Enabling the user to view dating profiles of the other users that their mobile phone numbers are included in the second contact circle of the user; and

(J) Enabling the user to communicate through said smartphone dating application with the users of said viewable dating profiles.

The method for the smartphone dating application may further include all or few of the following steps and features:

(K) Creating a third contact circle and a fourth contact circle for the user, on the same principles as of step (E) and to repeat the steps (F) until (J), mutatis mutandis.

(L) Displaying on the smartphone of the user the contact-chain-display between the user to the certain dating profile while the user viewing this certain dating profile.

(M) Enabling the user to associate his photo in contact lists of his first contact circle, wherein said photo includes a notification that he is a user of the smartphone dating application.

The samples, features and steps in this patent application and in the figures are just exanlples, and there may be many variations to these samples, features and steps, without departing from the spirit of the invention. For instance, the steps may be performed in a differing order, or steps may be added, deleted or modified. All of these variations are considered a part of the claimed invention. While the preferred embodiment to the invention has been described, it will be understood that those skilled in the art may make various improvements and enhancements which fall within the scope of the claims. These claims should be construed to maintain the proper protection for the invention as its concept described in this patent application.

What is claimed is:

1. A method for smartphone dating application performed by processing devices running on a smartphone and a server, comprising:
(a) enabling a user of the smartphone to create a dating profile;
(b) associating said dating profile with a mobile phone number of the user that is operated on said smartphone;
(c) enabling the user to share with said smartphone dating application mobile phone numbers of his contact list in said smartphone;
(d) listing said mobile phone numbers that are included in said contact list as a first contact circle of the user;
(e) creating a second contact circle for the user, wherein said second contact circle is based on the contact list of the user and on mobile phone numbers in contact lists that other users of the smartphone dating application shared with the smartphone dating application;
(f) identifying phone numbers that are associated with dating profiles of said other users with phone numbers that are included in the first contact circle and in the second contact circle of the user;
(g) classifying said dating profiles of said other users as being dating profiles of the first contact circle or as being dating profiles of the second contact circle;
(h) enabling the user to view the dating profiles of the other users that their mobile phone numbers are included in the first contact circle of the user;
(i) enabling the user to view dating profiles of the other users that their mobile phone numbers are included in the second contact circle of the user; and
(j) enabling the user to communicate through said smartphone dating application with the users of said viewable dating profiles.

2. The method for smartphone dating application according to claim 1, further comprising:
(a) creating a third contact circle for said user, wherein the third contact circle is based on said contact list of the user and on said mobile phone numbers in said contact lists that said other users of the smartphone dating application shared with the smartphone dating application;
(b) identifying said phone numbers that are associated with said dating profiles of said other users with phone numbers that are included in said third contact circle;
(c) classifying said dating profiles of said other users as being dating profiles of the third contact circle of the user;
(d) enabling the user to view the dating profiles of the other users that their mobile phone numbers are included in the third contact circle of the user; and
(e) enabling the user to communicate through said smartphone dating application with the users of said viewable dating profiles.

3. The method for smartphone dating application according to claim 2, further comprising:
(a) creating a fourth contact circle for said user, wherein the fourth contact circle is based on said contact list of the user and on said mobile phone numbers in said contact lists that said other users of the smartphone dating application shared with the smartphone dating application;
(b) identifying said phone numbers that are associated with said dating profiles of said other users with phone numbers that are included in said fourth contact circle;
(c) classifying said dating profiles of said other users as being dating profiles of the fourth contact circle of the user;
(d) enabling the user to view the dating profiles of the other users that their mobile phone numbers are included in the fourth contact circle of the user; and
(e) enabling the user to communicate through said smartphone dating application with the users of said viewable dating profiles.

4. The method for smartphone dating application according to claim 1, further comprising: displaying on said smartphone of said user a contact-chain-display between the user to a certain dating profile while the user viewing said certain dating profile.

5. The method for smartphone dating application according to claim 2, further comprising: displaying on said smartphone of said user a contact-chain-display between the user to a certain dating profile while the user viewing said certain dating profile.

6. The method for smartphone dating application according to claim 3, further comprising: displaying on said smartphone of said user a contact-chain-display between the user to a certain dating profile while the user viewing said certain dating profile.

7. The method for smartphone dating application according to claim 1, further comprising: enabling said user to associate his photo in contact lists of his first contact circle, wherein said photo includes a notification that he is a user of said smartphone dating application.
